(19) United States
(12) Patent Application Publication
(10) Pub. No.: US 2023/0097842 A1
(43) Pub. Date: Mar. 30, 2023

(54) PSEUDO RANDOM DOT PATTERN AND CREATION METHOD OF SAME

(71) Applicant: DEXERIALS CORPORATION, Shimotsuke-shi, Tochigi (JP)

(72) Inventor: Reiji TSUKAO, Utsunomiya-shi (JP)

(73) Assignee: DEXERIALS CORPORATION, Shimotsuke-shi, Tochigi (JP)

(21) Appl. No.: 17/798,145

(22) PCT Filed: Feb. 6, 2021
(86) PCT No.: PCT/JP2021/004473

§ 371 Date: Aug. 8, 2022

(30) Foreign Application Priority Data
Feb. 12, 2020 (JP) 2020-021965
Feb. 6, 2021 (JP) 2021-017871

(51) Int. Cl. G02B 5/02

(52) U.S. Cl. CPC G02B 5/0263

(57) ABSTRACT

A pseudo random dot pattern that is created easily by a geometric approach. The pseudo random dot pattern includes a first oblique lattice region and a second oblique lattice region repeatedly disposed at predetermined intervals in a y direction on an xy plane, a plurality of dot arrangement axes a1 on which dots are disposed at a predetermined pitch in an x direction being arranged in a b direction obliquely crossing the x direction at an angle α in the first oblique lattice region, a plurality of dot arrangement axes a2 on which dots are disposed at a predetermined pitch in the x direction being arranged in a c direction reverse to the b direction with respect to the x direction in the second oblique lattice region.

### TECHNICAL FIELD

The present invention relates to a pseudo random dot pattern and a creation method of the same.

### Background Art

A random dot pattern refers to a condition where dots are disposed in an unpredictable manner without regularity or reproducibility. In contrast, a pseudo random dot pattern looks like a random dot pattern but refers to a condition where dots are disposed in a predictable manner with regularity and reproducibility. Here, dots refer to small spots or structures.

A pseudo random dot pattern can be applied to a light diffusion sheet to prevent the occurrence of a diffraction pattern (Patent Literature 1, Patent Literature 2, and Patent Literature 3). In such a case, the dots must be free of overlap, the dot pattern must be irregular so that no moiré fringes occur, and the dot distribution must be uniform so that no unevenness is visually observable and must possess a predetermined number density.

Pseudo random dot patterns are also used for distance measurement etc. For example, a depth camera (Kinect (registered trademark) from Microsoft Corporation) using a projector in which microlenses are disposed in a pseudo random dot pattern has been known.

Among creation methods of a pseudo random dot pattern is a method described in Patent Literature 1, where the positions of respective dots are created using a linear feedback shift register. A molecular dynamics approach and the like have also been proposed (Non-Patent Literature 1).

### CITATION LIST

### Patent Literature

Patent Literature 1: Japanese Patent Application Laid-Open No. 2010-49267

Patent Literature 2: Japanese Translation of PCT Patent Application Publication No. 2006-502442

Patent Literature Japanese Translation of PCT Patent Application Publication No. 2019-510996

### Non-Patent Literature

Non-Patent Literature 1: The Special Interest Group Technical Reports of IPSJ, Vol. 2012-XL, No. 8, 2012/5/14

### SUMMARY OF INVENTION

### Technical Problem

There has been a demand for easy creation of a pseudo random dot pattern having a desired number density and periodicity in a short time in comparison to the conventional creation methods of a pseudo random dot pattern.

In view of the above-mentioned matters, an object of the present invention is to enable easier creation of a pseudo random dot pattern by a geometric approach.

### Solution to Problem

The present inventor has conceived that a pseudo random dot pattern can be created by repeatedly disposing a first oblique lattice region and a second oblique lattice region at intervals in a y direction on an xy plane, the first oblique lattice region including arrangement axes in a b direction obliquely crossing an x direction at an angle α, the second oblique lattice region including arrangement axes in a c direction reverse to the b direction with respect to the x direction, and completed the present invention.

More specifically, the present invention provides a pseudo random dot pattern including a first oblique lattice region and a second oblique lattice region repeatedly disposed at predetermined intervals in a y direction on an xy plane, a plurality of dot arrangement axes a1 on which dots are disposed at a predetermined pitch in an x direction being arranged in a b direction obliquely crossing the x direction at an angle α in the first oblique lattice region, a plurality of dot arrangement axes a2 on which dots are disposed at a predetermined pitch in the x direction being arranged in a c direction reverse to the b direction with respect to the x direction in the second oblique lattice region.

The present invention also provides a creation method or a pseudo random dot pattern, the creation method including repeatedly disposing a first oblique lattice region and a second oblique lattice region at predetermined intervals in a y direction on an xy plane, a plurality of dot arrangement axes a1 on which dots are disposed at a predetermined pitch in an x direction being arranged in a b direction obliquely crossing the x direction at an angle α in the first oblique lattice region, a plurality of dot arrangement axes a2 on which dots are disposed at a predetermined pitch in the x direction being arranged in a c direction reverse to the b direction with respect to the x direction in the second oblique lattice region.

This creation method of the pseudo random dot pattern can also be said to be a design method of the pseudo random dot pattern.

The present invention further provides a filler-containing film including a resin layer where filler particles are disposed in a pseudo random dot pattern on an xy plane, the filler-containing film including a first oblique lattice region and a second oblique lattice region repeatedly disposed at predetermined intervals in a y direction, a plurality of filler particle arrangement axes a1 on which filler particles are disposed at a predetermined pitch in an x direction being arranged in a b direction obliquely crossing the x direction at an angle α in the first oblique lattice region, a plurality of filler particle arrangement axes a2 on which filler particles are disposed at a predetermined pitch in the x direction being arranged in a c direction reverse to the b direction with respect to the x direction in the second oblique lattice region.

### Advantageous Effects of Invention

According to the present invention, the first oblique lattice region including the arrangement axes in the x direction and arrangement axes in the b direction obliquely crossing the x direction at an angle α, and the second oblique lattice region including the arrangement axes in the x direction and arrangement axes in the c direction reverse to the b direction with respect to the x direction (in other words, arrangement axes in the c direction obliquely crossing the x direction at an angle −α), are repeatedly disposed. The entire dot pattern is thus a pattern with undulated zigzagging axial directions crossing the x direction. The pseudo random dot pattern according to the present invention can thus be used in various products utilizing pseudo random dot patterns. For example, if the pseudo random dot pattern according to the present invention is used for a light diffusion sheet, a light diffusion sheet that produces no moiré fringes, is free of dot overlapping, and has no dot unevenness observable under microscopic observation can be obtained. If the pseudo random dot pattern according to the present invention is used for a dot projector, a pseudo random dot pattern for use in distance measurement and the like can be projected upon an object.

Since the pseudo random dot pattern according to the present invention has predetermined periodicity, products on which the pseudo random dot pattern is formed can be easily inspected to confirm actual formation of the pseudo random dot pattern.

### BRIEF DESCRIPTION OF DRAWINGS

FIG. 1A is a plan view for describing a dot disposition in a pseudo random dot pattern 10A according to an embodiment.

FIG. 1B is a plan view for describing a dot disposition in a pseudo random dot pattern 10B according to the embodiment.

FIG. 1C is a plan view for describing a dot disposition in a pseudo random dot pattern 10C according to the embodiment.

FIG. 1D is a plan view for describing a dot disposition in a pseudo random dot pattern 10D according to the embodiment.

FIG. 1E is a plan view for describing a dot disposition in a pseudo random dot pattern 10E according to the embodiment.

FIG. 1F is a plan view for describing a dot disposition in a pseudo random dot pattern according to the embodiment.

FIG. 1G is a plan view for describing a dot disposition in a pseudo random dot pattern according to the embodiment.

FIG. 1H is a plan view for describing a dot disposition in a pseudo random dot pattern according to the embodiment.

FIG. 1I is a plan view for describing a dot disposition in a pseudo random dot pattern according to the embodiment (representation using non-orthogonal coordinates).

FIG. 1J is a plan view for describing a filler particle disposition in a filler-containing film according to the embodiment.

FIG. 1K is a plan view for describing a filler particle disposition in a filler-containing film according to the embodiment.

FIG. 1L is a plan view for describing a filler particle disposition in a filler-containing film according to the embodiment.

FIG. 2A is a cross-sectional view of a filler-containing film 100A where filler particles are in a pseudo random dot pattern according to the embodiment.

FIG. 2B is a cross-sectional view of a filler-containing film 100B where filler particles are in a pseudo random dot pattern according to the embodiment.

FIG. 3 is a cross-sectional view of a filler-containing film 100C where filler particles are in a pseudo random dot pattern according to the embodiment.

FIG. 4A is a plan view of a fan-out-patterned area including radially arranged rectangular regions, on which the pseudo random dot pattern 10A according to the embodiment is placed.

FIG. 4B is a plan view of a parallel-patterned area including rectangular regions arranged in parallel, on which the pseudo random dot pattern 10A according to the embodiment is placed.

FIG. 5A is a diagram showing the overlap of each individual rectangular region constituting a fan-out-patterned area with filler particles in a simulation of thermally pressure-bonding a filler-containing film having substantially the same filler particle disposition as in experimental example 1 to the fan-out-patterned area.

FIG. 5B is a diagram showing the overlap of each individual rectangular region constituting a fan-out-patterned area with filler particles in a simulation of thermally pressure-bonding a filler-containing film having substantially the same filler particle disposition as in experimental example 3 to the fan-out-patterned area.

FIG. 5C is a diagram showing the overlap of each individual rectangular region constituting a fan-out-patterned area with filler particles in a simulation of thermally pressure-bonding a filler-containing film having substantially the same filler particle disposition as in experimental example 4 to the fan-out-patterned area.

FIG. 5D is a diagram showing the overlap of each individual rectangular region constituting a fan-out-patterned area with filler particles in a simulation of thermally pressure-bonding a filler-containing film having substantially the same filler particle disposition as in experimental example 5 to the fan-out-patterned area.

### DESCRIPTION OF EMBODIMENTS

An example of a pseudo random dot pattern according to the present invention will be described in detail below with reference to the drawings. In the drawings, the same reference numerals represent the same or similar components.

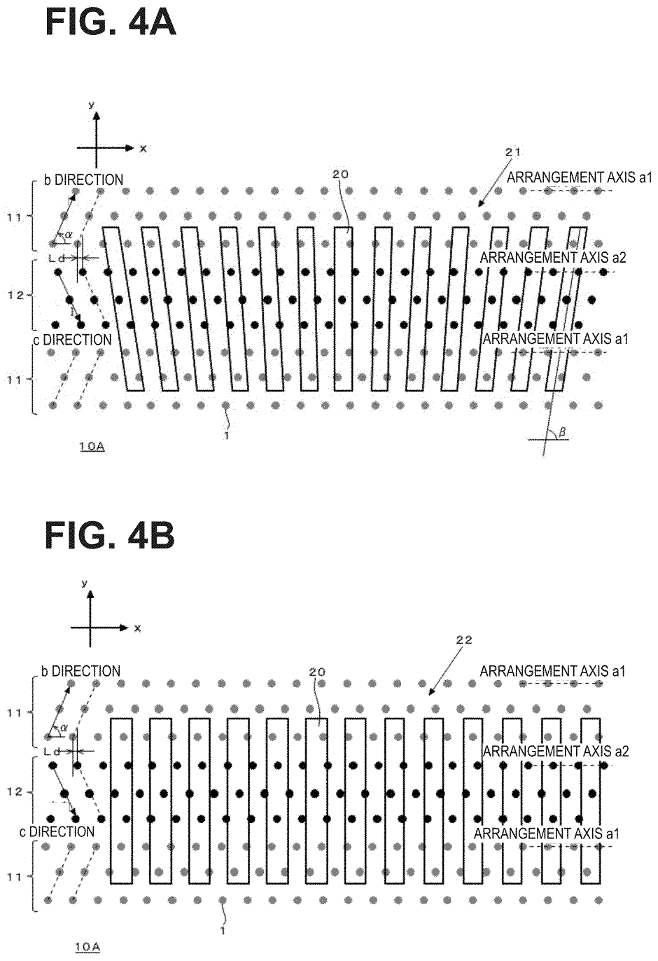

To evaluate the randomness of the pseudo random dot pattern according to the present invention, assume, as shown in FIG. 4A, that two articles each having a fan-out-patterned area 21 including radially arranged rectangular regions 20 are situated with their fan-out-patterned areas 21 opposed to each other, and a filler-containing film (a film including filler particles 1 disposed in the pseudo random dot pattern) that is an aspect of usage example of the pseudo random dot pattern is sandwiched therebetween and pressure-bonded or thermally pressure-bonded. Focus on how uniformly the rectangular regions 20 and the filler particles 1 overlap in the fan-out-patterned areas 21. The reason why the fan-out-patterned areas are assumed in evaluating the randomness of the pseudo random dot pattern is as follows: There are areas where rectangular regions 20 extend in a direction (y direction in the diagram) perpendicular to the short-side direction of the rectangular regions 20 (x direction in the diagram) and areas where rectangular regions 20 are inclined at different angles. Such areas are considered to be appropriate in evaluating randomness. If the filler particles 1 are uniformly disposed in the filler-containing film completely at random, the rectangular regions 20 and the filler particles 1 overlap uniformly in the fan-out-patterned areas 21. If, by contrast, the filler particles are disposed in the film in a lattice form such as a square lattice and a hexagonal lattice, a number of filler particles may overlap in one of the rectangular regions 20 in the fan-out-patterned areas 21 while on1y a few may overlap in another rectangular region 20.

For comparison, assume, as shown in FIG. 4B, that articles each having a parallel-patterned area 22 including rectangular regions 20 arranged in parallel instead of the fan-out-patterned areas 21 are pressure-bonded or thermally pressure-bonded with a filler-containing film. Focus similarly on how uniformly the rectangular regions 20 and the filler articles 1 overlap in the parallel-patterned areas 22.

### <Dot Pattern>

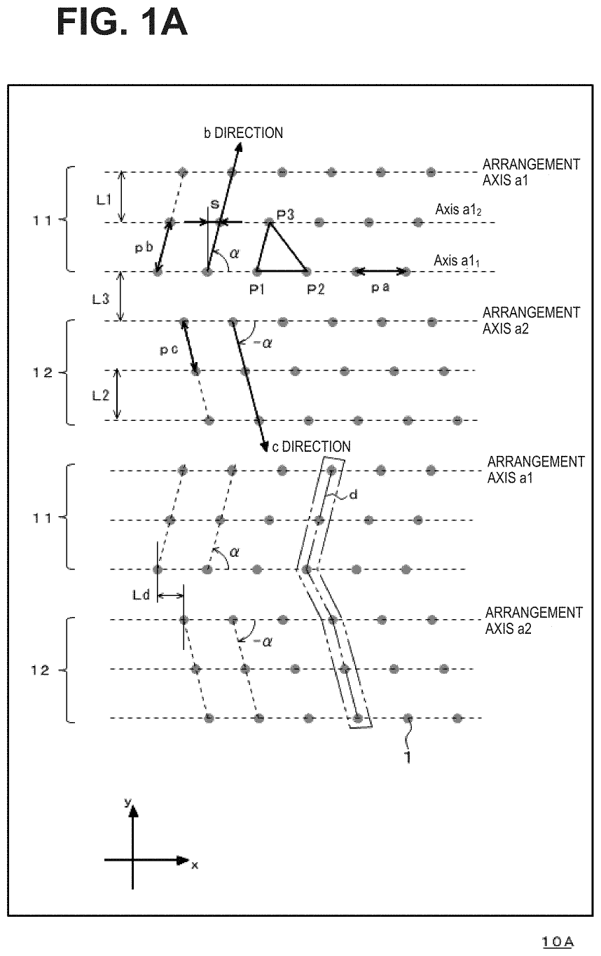

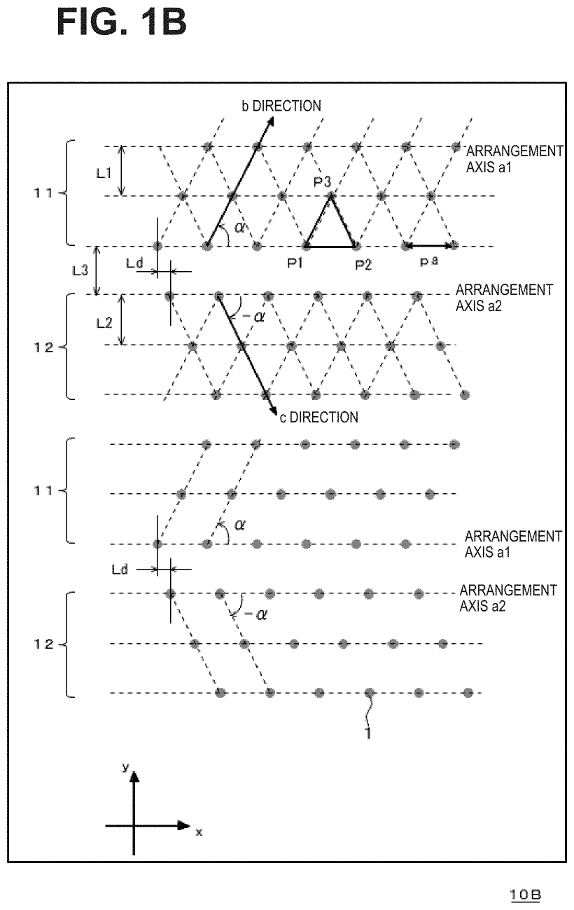

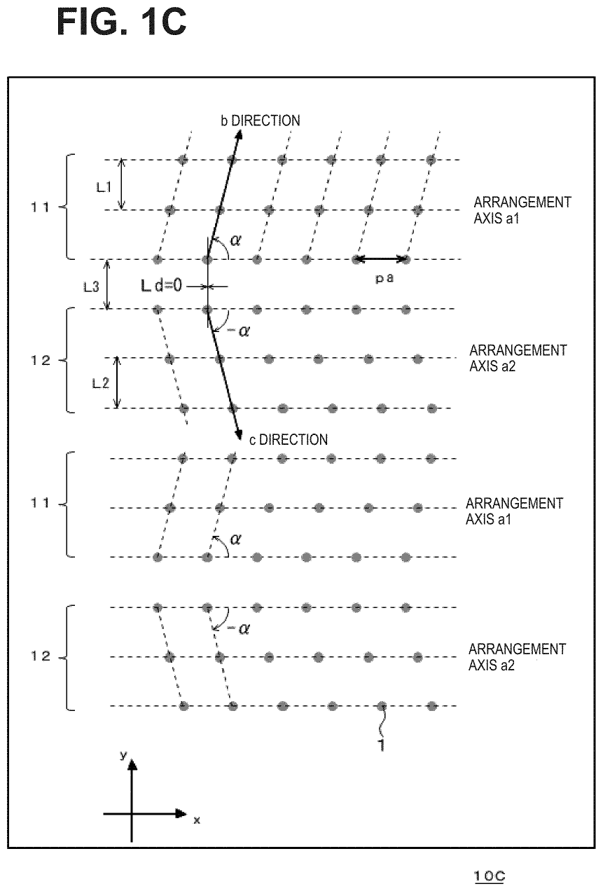

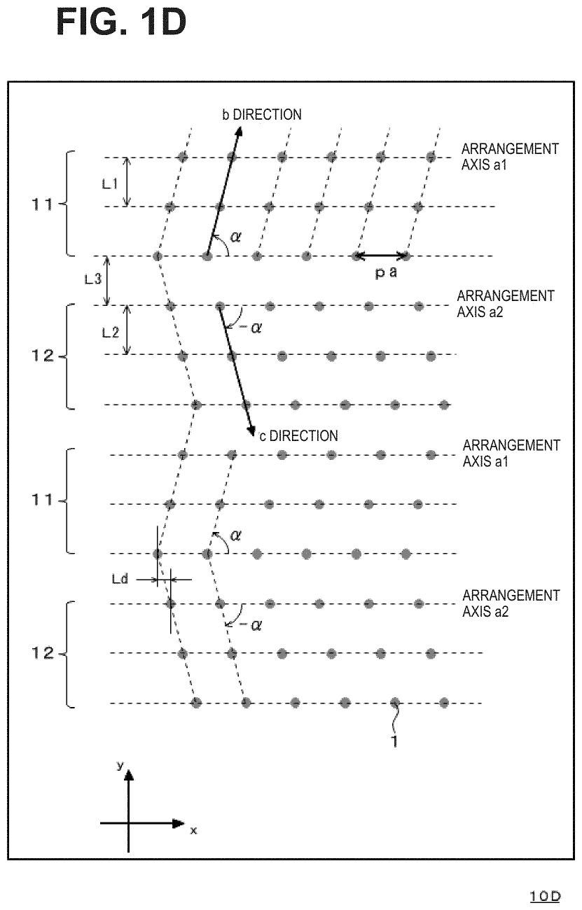

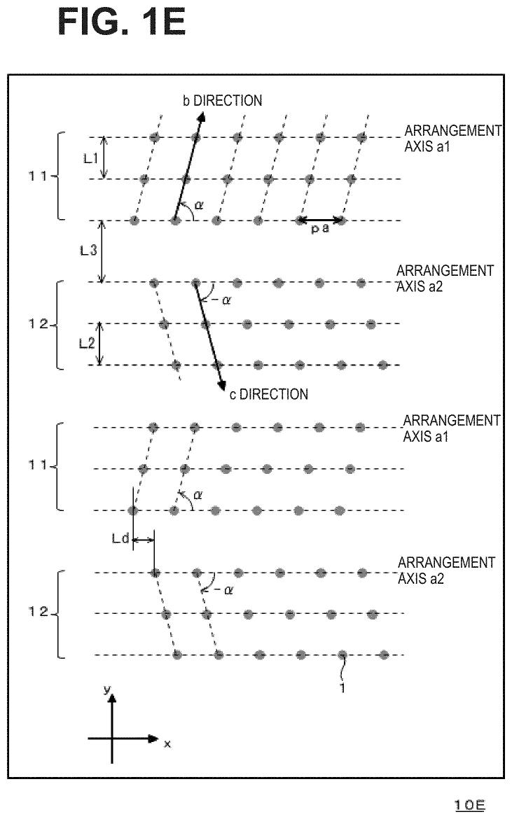

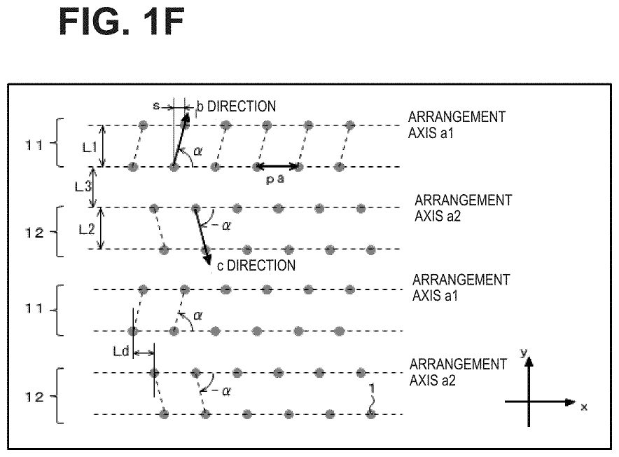

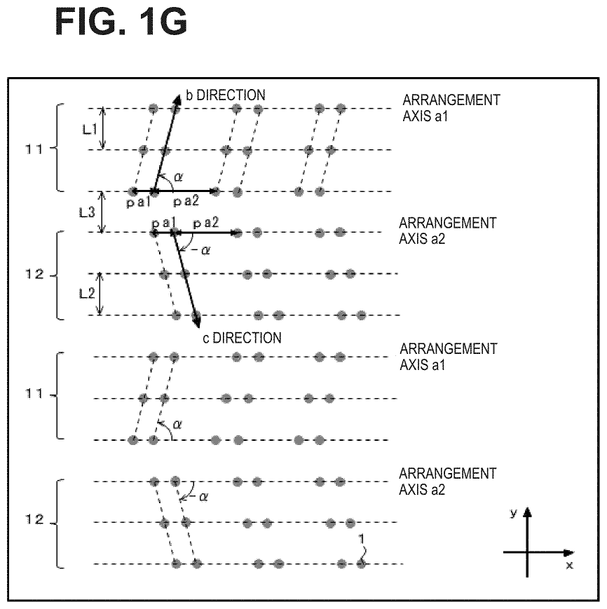

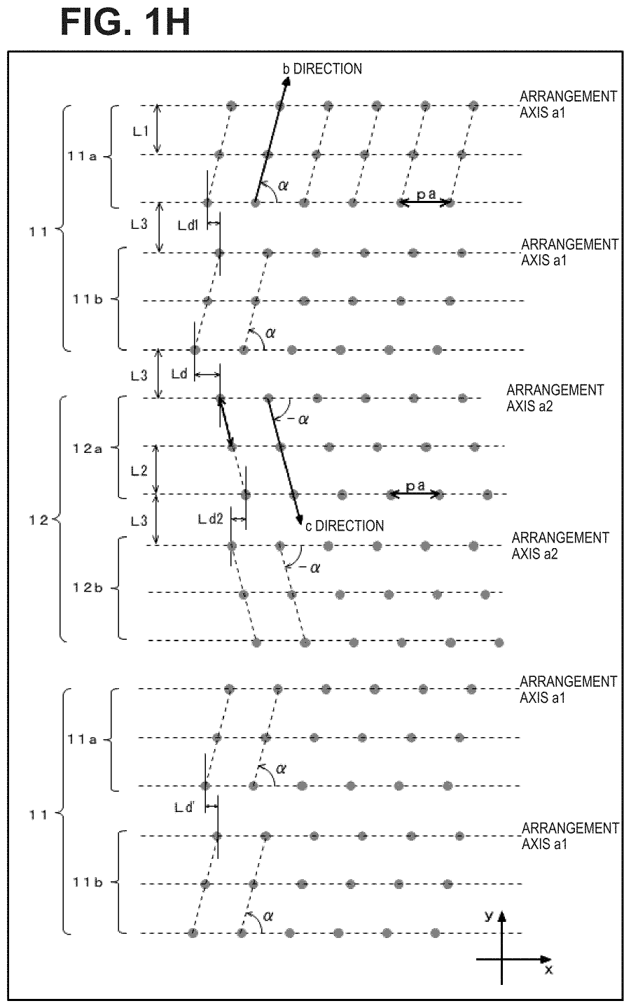

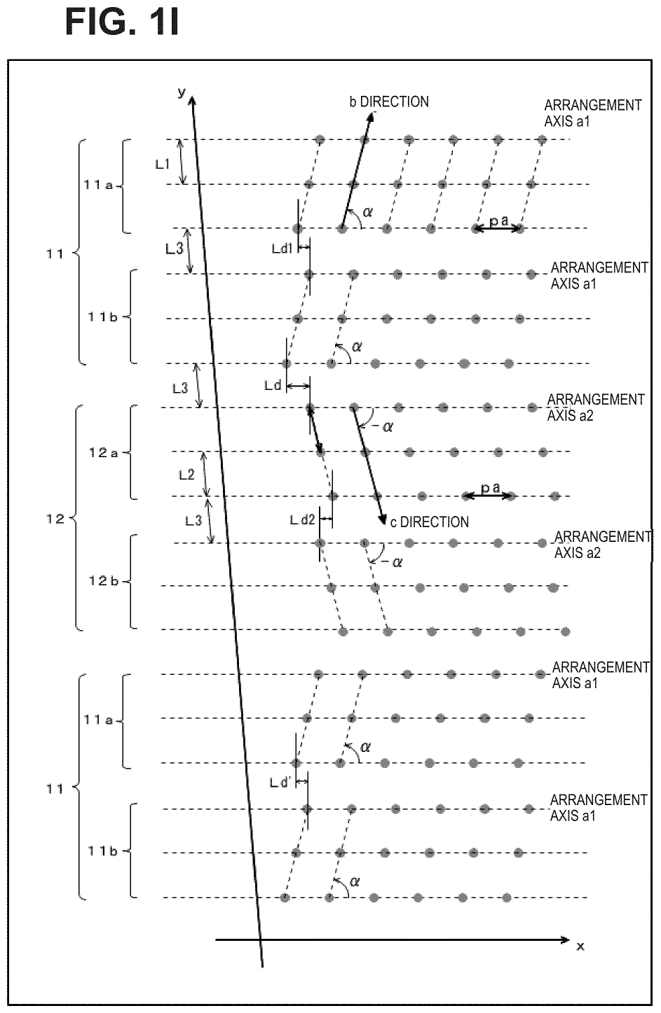

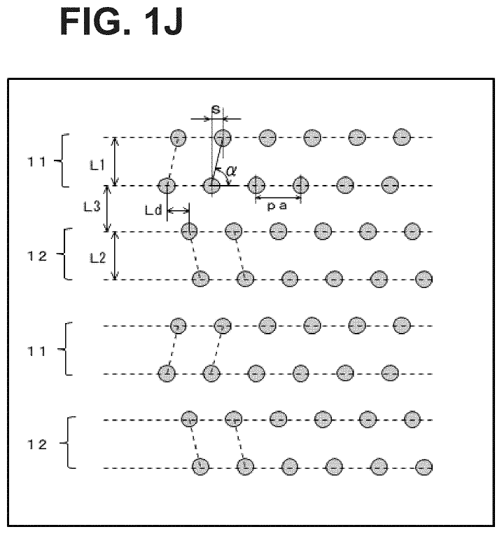

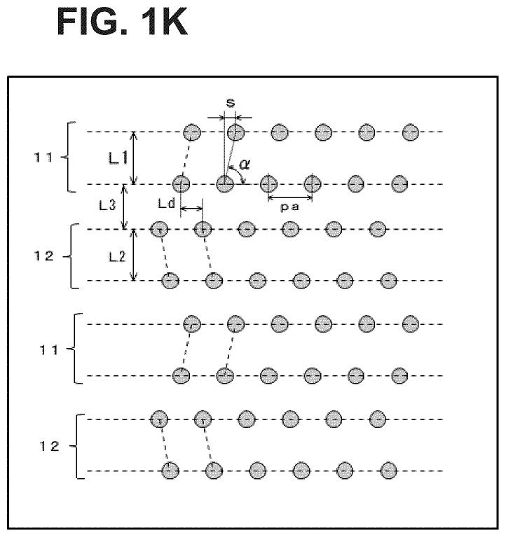

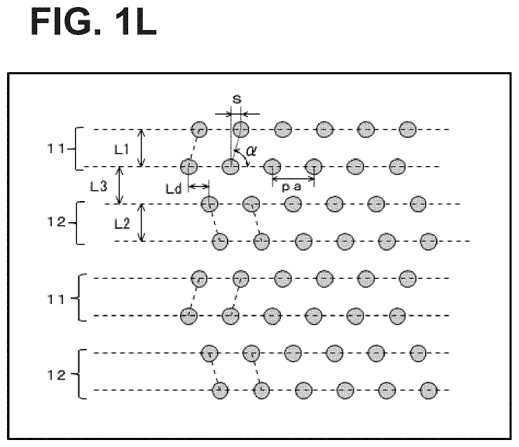

FIG. 1A is a plan view for describing a dot disposition in a pseudo random dot pattern 10A according to the embodiment.

This dot disposition includes a first oblique lattice region 11 and a second oblique lattice region 12 alternately repeatedly disposed in a y direction on an xy plane. As employed herein, the first oblique lattice region 11 is a region where a plurality of arrangement axes a1 on which dots 1 are disposed at a constant pitch pa in an x direction are arranged in a b direction obliquely crossing the x direction at an angle α. The second oblique lattice region 12 is a region where a plurality of arrangement axes a2 on which dots 1 are disposed at the pitch pa in the x direction are arranged in a c direction. The c direction is a direction reverse to the b direction with a straight line parallel to the x direction as the axis of symmetry. In other words, the c direction is a direction obliquely crossing the x direction at an angle −α. This dot disposition can thus be regarded as configured in units of a bent arrangement d including an arrangement in the b direction in the first oblique lattice region 11 and an arrangement in the c direction in the second oblique lattice region 12, surrounded by the double-dotted dashed line in FIG. 1A.

The dot pitch on the arrangement axes a2 of the second oblique lattice region 12 may be different from the dot pitch pa on the arrangement axes a1 of the fist oblique lattice region 11. However, for convenience of design of the dot disposition, the arrangement axes a2 and the arrangement axes a1 preferably have the same pitch pa. The dot pitch pa itself on the arrangement axes a1 of the first oblique lattice region 11 does not necessarily need to be constant if systematic. For example, two different pitches may appear at predetermined periods. The same applies to the dot pitch on the arrangement axes a2 of the second oblique lattice region 12.

As for the disposition of the dots 1, suppose that the first oblique lattice region 11 including the x direction and the b direction obliquely crossing the x direction as arrangement axes and the second oblique lattice region 12 including the x direction and the c direction reverse to the b direction as arrangement axes are alternately repeated as in the present embodiment. This uniformizes the extent of overlap of each rectangular region 20 with the dot pattern regardless of whether the extent of overlap is between the fan-out-patterned area 21 including the radially arranged rectangular regions 20 and the dot pattern as shown in FIG. 4A or between the parallel-patterned area 22 including the rectangular regions 20 arranged in parallel and the dot pattern as shown in FIG. 4B. This enables observation of the irregularity and uniformity of the dot pattern. By contrast, if the dot disposition in the dot pattern consists on1y of the first oblique lattice regions 11 or the second oblique lattice regions 12, variations in the number of dots overlapping each rectangular region 20 and variation in the distribution of dots in each rectangular region 20 increase. In such a case, the long-side direction or one of the rectangular regions 20 in the fan-out-patterned area 21 can be the same as the direction or an arrangement axis of dots 1 disposed in the oblique lattice, and the extent of overlap of dots 1 located at an edge of the rectangular region 20 can drop sharply. A dense area where a plurality of dots lie close to each other can be formed in any of the rectangular regions 20. The pseudo random dot pattern according to the present invention has excellent randomness and is less likely to cause such non-uniformity.

As will be described below, examples of use of the pseudo random dot pattern according to the present invention may include a filler-containing film where filler particles possessing functionalities such as a light diffusion property, electrical conductivity, heat dissipation property, and electromagnetic shielding property are disposed in a resin layer in the pseudo random dot pattern according to the present invention. FIGS. 4A and 4B show examples where the filler-containing film is thermally pressure-bonded between two articles which have a fan-out-patterned area 21 or a parallel-patterned area 22. In thermally pressure-bonding the articles, it is desirable for the x direction that is the direction of the arrangement axes a1 or the arrangement axes a2 of the filler particles (dots) 1 to be the same as the arrangement direction of the rectangular regions 20 because the numbers of dots overlapping the rectangular regions shown to the left of the diagrams and those shown to the right of the diagrams are the same. For convenience of use of the filler-containing film, it is desirable for the direction of the arrangement axes a1 or the arrangement axes a2 to be the same as the long-side direction of the filler-containing film. Alternatively, it is desirable for the short-side direction of the rectangular regions 20 (x direction) to be set to the long-side direction of the filler-containing film. It is desirable for the number of repetitions of the first oblique lattice region 11 and the second oblique lattice region 12 of the filler-containing film to be sufficient with respect to the length of the rectangular regions 20 in their long-side direction (y direction). For example, it is preferable that the number of repetitions be one times or more for the length of the rectangular regions 20 in the long-side direction, more preferably three times or more. In other words, it is preferable that the repetition pitch of the first oblique lattice region 11 and the second oblique lattice region 12 of the filler-containing film in the y direction be less than or equal to the length of the rectangular regions 20 in the long-side direction, more preferably ⅓ or less. Alternatively, it is desirable for the number of bends of the arrangement axis formed of an arrangement axis of the first oblique lattice region 11 in the b direction and an arrangement axis of the second oblique lattice region 12 in the c direction to be determined so that the number of filler particles overlapping each rectangular region 20 reaches or exceeds a predetermined number or falls within a predetermined range. The number of filler particles is determined on the basis of the purpose and usage. For example, the number of filler particles may be determined to be three or more, and more preferably 11 or more. It will be understood that the number of filler particles is not limited thereto.

In the first oblique lattice region 11, the angle α formed between the x direction of the arrangement axes a1 and the b direction has an absolute value less than the minimum value of the absolute values of the fan-out angle β if the filler-containing film is thermally pressure-bonded to the fan-out-patterned area 21. This makes the long-side direction of any of the rectangular regions 20 constituting the fan-out-patterned area 21 different from the b direction in the first oblique lattice region 11. This can prevent the extent of overlap of filler particles located at the edges of a rectangular region 20 in the long-side direction with the rectangular region from dropping sharply, and a large number of filler particles from being interconnected on a rectangular region 20. Now, suppose that the area to be thermally pressure-bonded to the filler-containing film is the parallel-patterned area 22 (FIG. 4B) where the rectangular regions 20 which have a long-side direction orthogonal to the x direction are arranged in parallel in the x direction, or a parallel-patterned area (not shown) where rectangular regions which have a long-side direction obliquely crossing the x direction are arranged in parallel in the x direction. In such a case, it is desirable for the angle α to have an absolute value less than or equal to that of the angle β formed between the arrangement direction of the rectangular regions 20 and the long-side direction of the rectangular regions 20. The reason for this is that the number of the filler particles overlapping the rectangular regions are stable if the arrangement direction of the rectangular regions 20 and the long-side direction of the rectangular regions 20 are orthogonal. Even if the rectangular regions 20 include those of which the arrangement direction extends in the x direction and those of which the arrangement direction extends in the y direction, such an angle α is desirable because the numbers of filler particles overlapping the rectangular regions 20 are stable.

In the second oblique lattice region 12, the c direction is a direction reverse to the b direction with respect to the x direction. The angle formed between the x direction and the c direction is −α. Setting the angle α as described above also makes the long-side directions of the rectangular regions 20 different from the c direction in the second oblique lattice region 12. This can provide effects similar to the above-mentioned effects.

If the angle α is 90°, the filler particle disposition in the first and second oblique lattice region 11 and 12 forms a square lattice or rectangular lattice. The angle α may therefore be expressed as the amount of distortion s of the square lattice or rectangular lattice in the x direction (FIG. 1A). If the amount of distortion s is greater than the average diameter of the filler particles, the filler particles in the same oblique lattice region are less likely to be interconnected in the y direction on one rectangular region when the filler-containing film and the rectangular regions 20 are thermally pressure-bonded. On the other hand, if the amount of distortion s is less than or equal to the average diameter of the filler particles, preferably less than the average diameter, the filler particles in the filler-containing film and the rectangular regions 20 of even a small width are more likely to overlap.

The angle that the c direction forms with the x direction does not need to be exactly the same as that obtained by inverting the sign of the angle α. In other words, the absolute value of the angle that the b direction forms with the x direction and the absolute value of the angle that the c direction forms with the x direction do not need to be exactly the same, and may vary from one oblique lattice region to another. In such a case, it is desirable for the total of such angles in all the oblique lattice regions to be 0°.

Now, the center positions of adjoining dots on a given arrangement axis a1₁ will be denoted as P1 and P2, and the center position of a dot that is located on an arrangement axes a1 (a1₂) adjoining the arrangement axis a1₁ and located between P1 and P2 in the x direction will be denoted as P3. In this case, as shown in FIG. 1A, if ∠P3P1P2≠∠P3P2P1, the dot disposition in the first oblique lattice region 11 and the dot disposition in the second oblique lattice region 12 are different and line-symmetric. The dot dispositions do not overlap if the regions are translated. In other words, the extension of a given arrangement axis obliquely crossing the x direction in one of the oblique lattice regions 11 and 12 does not serve as an arrangement axis in the other.

By contrast, if ∠P3P1P2=∠P3P2P1 as shown in FIG. 1B, the dot disposition in the first oblique lattice region 11 and the dot disposition in the second oblique lattice region 12 are themselves the same. Assume here that:

the distance between the first oblique lattice region 11 and the second oblique lattice region 12 is L3,

the distance between adjoining arrangement axes a1 in the first oblique lattice region 11 is L1,

the distance between adjoining arrangement axes a2 in the second oblique lattice region 12 is L2,

the amount of deviation in the x direction between positions of the closest dots on an arrangement axis a1 of the first oblique lattice region 11 and an adjoining arrangement axis a2 of the second oblique lattice region 12 is Ld, and

the pitch on the arrangement axes a1 and a2 is pa. If L3=L1=L2 and Ld=(1/2)×pa, there are arrangement axes in the second oblique lattice region 12 that are in the same direction as the arrangement axes of the first oblique lattice region 11 in the b direction, and the extensions of the arrangement axes of the second oblique lattice region serve as the arrangement axes of the first oblique lattice region in the b direction. If, regarding the arrangement axes obliquely crossing the x direction, an arrangement axis in one of the two oblique lattice regions 11 and 12 thus serves simply as that of the other oblique lattice region, the arrangement axes crossing the x direction are not zigzagged in the entire dot pattern. Such a dot disposition fails to provide the effect of the present invention. Such a dot disposition is therefore excluded from the present invention.

On the other hand, ∠P3P1P2≠∠P3P2P1 provides the effect of the present invention even if L3=L1=L2 and Ld=(1/2)×pa. For example, if the average diameter of the filler particles is 3.2 μm and the numbers of arrangement axes in the x direction in the respective first and second oblique lattice regions 11 and 12 are two, dots can be disposed so that L1=L2=L3=9.5 μm, pa=9 μm, Ld=(1/2)×pa=4.5 μm, the amount of distortion s=2.25 μm, α=76°, and the number density is 12000 pieces/mm² (FIG. 1J).

If filler particles with the same average diameter are used and the numbers of arrangement axes in the x direction in the respective first and second oblique lattice regions 11 and 12 are two, dots can be disposed so that L1=L2=10.4 μm, L3=8.8 μm, pa=8.8 μm, Ld=(1/2)×pa=4.4 μm, the amount of distortion s=2.2 μm, α=78°, and the number density is 12000 pieces/mm² (FIG. 1K).

If filler particles with the same average diameter are used and the numbers of arrangement axes in the x direction in the respective first and second oblique lattice regions 11 and 12 are two, dots can also be disposed so that L1=L2=L3=7.5 μm, pa=8.4 μm, Ld=(1/2)×pa=4.2 μm, the amount of distortion s=2.1 μm, α=75°, and the number density is 16000 pieces/mm² (FIG. 1L). The pitch pa can thus be greater than L1, L2, and L3.

In the aspects shown in FIGS. 1J, 1K, and 1L, the amount of deviation Ld is one half of the pitch pa, and the amount of distortion s is one half of the amount of deviation Lb. Such a relationship between the pitch pa, the amount of deviation Ld, and the amount of distortion s is preferable for convenience of design of the pseudo random dot pattern according to the present invention. This also facilitates identification of the dot disposition condition after the dot pattern is formed on a given object such as a film, a resin plate, a glass, and a piece of metal. The amount of deviation Ld and the amount of distortion s can easily be observed by drawing additional lines connecting the centers or circumscribing lines of filler particles on a captured image of the filler-containing film, for example.

Even with ∠P3P1P2=∠P3P2P1 as shown in FIG. 1B, the first oblique lattice region 11 and the second oblique lattice region 12 can be identified as separate regions if L3≠L1 or L2, or Ld≠(1/2)×pa. The arrangement axes crossing the x direction are zigzagged in the entire dot pattern, and the effect of the present invention can be obtained.

In the present invention, the amount of deviation Ld is preferably nonzero in view of providing irregularity and uniformity while appropriately increasing the dot-to-dot distance in the y direction in the dot pattern and ensuring a predetermined number density (pieces/mm²) of the dot distribution. More specifically, if the amount of deviation Ld is zero, the dots in the first and second oblique lattice regions adjoining in the y direction overlap in the y direction. If a filler-containing film with such a dot pattern is formed and thermally pressure-bonded to a predetermined object, the inter-filler-particle distance in the portions where the filler particles in the first oblique lattice region and those in the second oblique lattice region overlap in the y direction is so small that the filler particles can easily be interconnected. It is therefore desirable for the absolute value of the amount of deviation Ld to be greater than zero, more preferably 0.5 times or more the average dot diameter, further preferably one times or more the average dot diameter, and particularly preferably greater than one times the average diameter. Meanwhile, the upper limit of the amount of deviation Ld is preferably 0.5 times or less the pitch pa on the arrangement axes a1 and a2, more preferably less than 0.5 times, and still further preferably 0.3 times or less.

FIG. 1C shows a dot disposition obtained by setting the amount of deviation Ld to 0 in regards to the dot disposition shown in FIG. 1A. The amount of deviation Ld may be set to 0 if the distance L3 is greater than the amount of movement of filler particles during thermal pressure bonding if a filler-containing film having this dot pattern is formed and thermally pressure-bonded to a given object.

FIG. 1D shows a dot disposition obtained by adjusting the amount of deviation Ld in regards to the dot disposition shown in FIG. 1A so that the arrangement axes of the first oblique lattice regions 11 in the b direction and those of the second oblique lattice regions 12 in the c direction intersect at dots 1. The axes of symmetry in reversing the b and c directions thus fall on the arrangement axes a1 or a2, and the reversed shapes are repeated in the y direction without a break. This may facilitate the design of the dot disposition and inspection steps after disposition.

FIG. 1E shows a dot disposition obtained by making the distance L3 between the first and second oblique lattice regions 11 and 12 in regards to the dot disposition shown in FIG. 1A different from the distance L1 between the adjoining arrangement axes a1 in the first oblique lattice region 11 or the distance L2 between the adjoining arrangement axes a2 in the second oblique lattice region 12. In the present invention, for convenience of design of the dot disposition and for ease of comparison of dot densities in predetermined areas, it is desirable for the distances L1, L2, and L3 to be set so that L1=L2 or L1=L2=L3. If needed, the distances L1, L2, and L3 may be set so that L3≠L1 or L2, or L1≠L2.

The distances L1 and L2 are preferably determined on the basis of the layout of the regions to be thermally pressure-bonded. The distances L1 and L2 themselves are not limited to any particular upper limit or lower limit. For example, smaller distances L1 and L2 facilitate filler particles to overlap with the regions to be thermally pressure-bonded, but can also result in easy interconnection of filler particles. The distances L1 and L2 are therefore preferably 1.4 times or more the average diameter of the filler particles.

It is desirable for the pitch pa of the filler particles on the arrangement axes a1 of the first oblique lattice region 11 and the arrangement axes a1 of the second oblique lattice region 12 to be determined on the basis of the layout and the like of the regions to be thermally pressure-bonded, and there is no particular upper or lower limit. For example, the pitch pa is preferably 1.5 times or more the average diameter of the filler particles, and can be greater than or equal to twice the average diameter plus 0.5 μm, since too small a pitch pa results in easy interconnection of filler particles.

On the other hand, the number of filler particles needed for the filler-containing film can be reduced by increasing the pitch pa. If the regions to be thermally pressure-bonded have a small width but are of a sufficient length, the number of filler particles overlapping the regions to be thermally pressure-bonded should satisfy a predetermined number. If the arrangement direction of the regions to be thermally pressure-bonded is the same as the x direction, it is desirable for the pitch pa to be ½ to ⅔ the minimum width of the effective connection areas resulting from the connection of the regions to be thermally pressure-bonded via the filler-containing film.

In terms of making the dot distribution state uniform over the entire surface, it is desirable for the distances L1, L2, and L3 and the pitch pa to be the same. In other words, it is desirable that the dots in the respective first and second oblique lattice regions 11 and 12 be disposed in oblique lattices obtained by distorting square lattices in the x direction, and the distance L3 between the first and second oblique lattice regions 11 and 12 be the same as the lattice pitches.

FIG. 1F shows a dot disposition obtained by changing the number n1 of arrangement axes a1 arranged in the first oblique lattice region 11 and the number n2 of arrangement axes a2 arranged in the second oblique lattice region 12 in regards to the dot disposition shown in FIG. 1A to two. FIGS. 1J, 1K, and 1L described above are more specific aspects of embodiment thereof. In the present invention, it is desirable for the number n1 of arrangement axes a1 arranged in the first oblique lattice region 11 and the number n2 of arrangement axes a2 arranged in the second oblique lattice region 12 to be the same but may be different. If a filler-containing film which contains the pseudo random dot pattern according to the present invention is formed and thermally pressure-bonded to an article, the numbers n1 and n2 of arrangement axes arranged can be determined on the basis of the layout of the regions to be thermally pressure-bonded and thus are not limited in particular. If the regions to be thermally pressure-bonded are arranged at a fine pitch, the numbers n1 and n2 of arrangement axes arranged are preferably 10 or less, more preferably four or less, still further preferably three or less, and particularly preferably two, so that filler particles reliably overlap the regions to be thermally pressure-bonded and the filler particles are prevented from being interconnected. The reason for this is that if the number n1 of arrangement axes a1 arranged in the first oblique lattice region and the number n2 of arranged axes a2 arranged in the second oblique lattice region are two to four, the zigzag arrangement axes are at a finer pitch compared with cases with more arrangement axes. If the filler-containing film is thermally pressure-bonded to fan-out-patterned areas, this can make the distribution state of the filler particles in the right and left regions of the fan-out-patterned areas more uniform and further reduce contact of filler particles with each other. While the above-described description has dealt with thermal pressure bonding, it is assumed that a functionality can be exerted by forming a large number of arrangements of fine dots depending on the purpose of use. The limit of the numbers of arrangement axes arranged can therefore be determined on the basis of the intended purpose.

FIG. 1G shows a dot disposition obtained by changing the dot pitch of the first oblique lattice region 11 in the x direction in regards to the dot disposition shown in FIG. 1A so that different pitches pa1 and pa2 are alternately repeated instead of the single pitch pa. The dot pitches pa1 and pa2 in the x direction are alternately repeated in the second oblique lattice region 12 as well. In the present invention, the pitch of dots disposed in the x direction thus does not necessarily need to be constant if systematic.

FIG. 1H shows a dot disposition obtained by providing two first oblique lattice regions 11a and 11b in the first oblique lattice region 11 of the dot disposition shown in FIG. 1A so that their arrangement axes in the b direction deviate from each other in the x direction, and also providing two second oblique lattice regions 12a and 12b in the second oblique lattice region 12 so that their arrangement axes in the c direction deviate from each other in the x direction. In such a case, the amount of deviation Ld1 between the arrangement axes a1 of the two adjoining first oblique lattice regions 11a and 11b in the x direction and the amount of deviation Ld2 between the arrangement axes a2 of the two adjoining second oblique lattice regions 12a and 12b in the x direction may be the same or different.

As described above, in the present invention, the first and second oblique lattice regions do not necessarily need to be alternately repeated if repeated in the y direction. The positions of the dot patterns in the x direction in the first oblique lattice regions repeated in the y direction and the positions of the dot patterns in the x direction in the second oblique lattice regions repeated in the y direction may be the same or different. Meanwhile, regarding a unit length in the y direction, it is desirable for the total number of repetitions of the arrangement axes a1 of the first oblique lattice regions in the y direction and the total number of repetitions of the arrangement axes a2 of the second oblique lattice regions in the y direction to be the same.

In the present invention, the xy coordinates are not limited to orthogonal coordinates. For example, FIG. 1I is a representation of the foregoing dot disposition shown in FIG. 1H using non-orthogonal coordinates where the x direction and the y direction are not orthogonal. For convenience of design, it is preferable to use orthogonal coordinates.

### (Dot Configuration)

In the present invention, the dots disposed in the pseudo random dot pattern refer to small spots or structures. The small spots may include various fillers and other small solid bodies. The structures refer not only to convexes and protrusions but also to shapes such as concaves and recesses. The dot configuration can be determined as appropriate on the basis of the object to which the pseudo random dot pattern is provided. For example, in the case of a moth-eye film, the dots can be nanostructures formed as concaves or convexes in/on a transparent resin substrate. In the case of an embossed film, the dots can be concaves or convexes of micron order. In the case of a light diffusion sheet, the dots can be a light diffusing filler. In the case of an electrically functional sheet, an electromagnetic shielding sheet, and the like, the dots can be a conductive filler. In the case of a heat dissipation sheet, the thermal conductivity of the dots is adjusted on the basis of the substrate to retain the dots. Here, the heat transfer rate may be changed. The surface area may be increased. In the case of a dot projector, the dots can be microlenses.

The dots may have the shape of filler particles themselves or a transferred shape of the filler particles. The dots may have a spherical or similar protruding shape (round shape), a rod-like shape, or a flexible shape. The dots may have a tip end with a pointed shape or a round shape. The dots may have a composite shape like a spherical shape with even smaller adhering substances. The aspect ratios (the lengths in the xy plane directions with respect to a height or depth) of the dots can be adjusted as appropriate depending on the functionality, and are not limited in particular.

Specific examples of the dot configuration itself may include those described in Japanese Patent Application Laid-Open Nos. 2018-124595, 2016-29446, and 2015-132689, and WO 2016/068166, WO 2016/068171, WO 2018/074318, WO 2018/101105, and WO 2018/051799.

### <Size and Number Density of Dots>

In the present invention, the size of the dots 1 and the number density of the dots 1 (pieces/mm²) on the XY plane can be appropriately set depending on the object to which the pseudo random dot pattern is provided. The size of the dots is usually less than 1000 μm in diameter, such as several tens of nanometers to several hundreds of micrometers, and can be greater than or equal to the visible light wavelengths and not greater than 200 μm. The lower limit of the number density can be usually 10 pieces/mm² or more, or 30 pieces/mm² or more. The upper limit can be determined in the range of 10⁹ pieces/mm² or less, 10⁷ pieces/mm² or less, 10⁵ pieces/mm² or less, or 70000 pieces/mm² or less. The dots 1 may have a size of less than several tens of nanometers. In particular, if the dots are filler particles, the upper limit of the particle diameter of the filler is 200 μm or less, preferably 50 μm or less, and more preferably 30 μm or less, in view of workability during manufacturing. The lower limit of the particle diameter of the filler is 0.5 μm or more, preferably 0.8 μm or more, and more preferably 1 μm or more, in view of inspection during manufacturing.

For example, if a pseudo random dot pattern of nanostructures is disposed on a transparent substrate to constitute an optical structure such as a moth-eye film or a concavo-convex structure, the number density of the nanostructures can be (10 to 1000)×10⁶ pieces/mm².

In the present invention, the filler may have an optical function (function that an optical element may have, such as light intensity adjustment, optical filtering, light diffusion, light shielding, and optical wavelength conversion, or absorbability of pigment to a specific wavelength, etc.), an insulating property, electrical conductivity, thermal conductivity, etc. The filler may have properties used for surface treatment, such as hydrophilic and lipophilic properties. If such a filler is disposed in a pseudo random dot pattern on a resin layer to obtain a functional film (or a functional surface) which has various optical characteristics, an electromagnetic shielding property, electrical conductivity, a heat dissipation property, a surface modification property, or the like, the number density of the filler can be 500000 pieces/mm² or less, 350000 pieces/mm² or less, 10 to 100000 pieces/mm², or 30 to 70000 pieces/mm². More specifically, if, for example, a light diffusion filler is disposed in a pseudo random dot pattern on a resin layer to constitute a light diffusion sheet, the number density of the light diffusion filler particles which have a filler particle diameter of 1 or more μm can be 100 to 500000 pieces/mm², and preferably 10 to 100000 pieces/mm².

The number density of the dots can be determined using a metallurgical microscope, an electron microscope (such as an SEM and a TEM), or the depending on the dot size. The number density may be measured using a three-dimensional surface measuring instrument. The number density may also be determined by measuring observation images using image analysis software (such as WinROOF from MITANI Corporation and A-Zo Kun (registered trademark) from Asahi Kasei Engineering Corporation).

In the present invention, the number density of the dots is the same as that in a case where the angle α is 90° and the first and second oblique lattice regions 11 and 12 are configured not as an oblique lattice but as a square or rectangular lattice. The pitch pa and the distances L1 and L2 can thus be determined by calculating inter-lattice distances using such a square or rectangular lattice.

### <Use Applications of Pseudo Random Dot Pattern>

Aside from various use applications where pseudo random dot patterns have conventionally been provided, the pseudo random dot pattern according to the present invention may be used in applications where a pseudo random dot pattern has not necessarily been required. For example, the pseudo random dot pattern according to the present invention can be used for a moth-eye film, a dot projector, a light diffusion sheet, etc., as well as for functional films or the like with various functions including optical wavelength conversion, electrical conductivity, a heat dissipation property, and electromagnetic shielding. The pseudo random dot pattern can be used for daily commodities and materials thereof, utilizing surface properties. Producing methods themselves of such items can be similar to conventional ones. In providing a pseudo random dot pattern on a predetermined object, the pseudo random dot pattern does not necessarily need to be disposed over the entire surface of the object. For example, a pseudo random dot pattern may be scattered like island structures.

The pseudo random dot pattern is a mode of regular arrangement, and can be used in a use application intermediate between one where a conventional random pattern provided and one where dots are regularly disposed in a rectangular, right polygonal, or other lattice-like configurations. Among these, examples of the usage include detailed inspection of the respective effects of a random arrangement and a regular arrangement. For example, the wettability of nanostructures can be controlled by controlling the aspect ratios and repetition pitches of the structures and the material-based contact angle. Here, the pseudo random dot pattern is expected to enable wettability direction control. The use of the pseudo random dot pattern is also expected to improve functionality and develop new functions in applications where properties depend on the surface configuration of nanometer to micrometer order (such as electrode materials and osmosis membranes), in life science, and in medical and biotechnological applications (such as cell disruption and cell culture). Moreover, the concave and convex shapes disposed in the pseudo random dot pattern can be used as a die. In various applications of the pseudo random dot pattern, there may be a layer other than the layer with the pseudo random dot pattern. For example, a layer formed by providing a pseudo random dot pattern of filler particles on a film member or a pseudo random dot pattern of concave and convex structures on a film surface may be disposed on another object via a pressure-sensitive adhesive or an adhesive. Another layer may be interposed between the film member with the pseudo random dot pattern and another object. The publications cited above may be referred to for the producing methods of such products.

As described above, the pseudo random dot pattern can be developed in various ways depending on the combination with the base material for the pseudo random dot pattern to be provided on. Articles obtained by providing the pseudo random dot pattern of the present invention for various applications are also included in the present invention.

### <Producing Method of Pseudo Random Dot Pattern>

Conventional methods can be used as the producing method itself of the pseudo random dot pattern. For example, moth-eye films and similar products can be manufactured as described in WO 2012/133943. Products using a filler can be manufactured as described in WO 2016/068166, WO 2016/068171, WO 2018/074318, WO 2018/101105, and WO 2018/051799 cited above.

As a producing method of various types of sheets which uses small solid bodies such as a light diffusing filler, an insulating filler, and a conductive filler, a resin layer of the intended sheet is formed on a releasing base material which has a smooth surface like a PET film. Meanwhile, a metal die with a pseudo random dot pattern of concave portions is formed, and a resin is poured into the metal die to form a resin die. The concave portions of the resin die are filled with small solid bodies, the foregoing resin layer is stacked thereon, and the small solid bodies are transferred to the resin layer. The small solid bodies are pushed into the resin layer, and if needed, a resin layer is further stacked thereon. A sheet in which the small solid bodies are disposed in the pseudo random dot pattern in a plan view can thereby be obtained. Using the sheet including the resin layer where the small solid bodies are provided, processing for disposing small solid bodies on the surface of a separate object can also be performed. More specific examples of the producing method of a filler-containing film itself may include the methods described in WO 2016/068171, WO 2018/74318, WO 2018/101105, and WO 2018/051799.

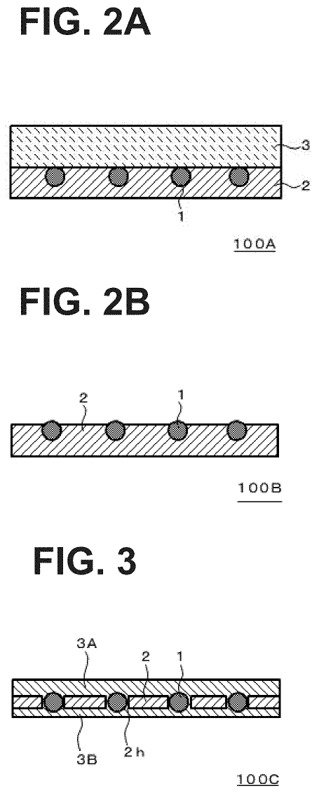

For example, as shown in FIG. 2A, a filler-containing film 100A having a layer configuration where a single layer of a filler (small solid bodies) 1 is disposed in a pseudo random dot pattern on or near the surface of an insulating resin layer 2, and a low-viscosity resin layer 3 is stacked thereon can thereby be obtained. As shown in FIG. 2B, a filler-containing film 100B having a layer configuration where the low-viscosity resin layer 3 is omitted may be formed. Like a filler-containing film 100C shown in FIG. 3, a layer configuration where through holes 2h are formed in a pseudo random dot pattern in an insulating film 2, a filler (small solid bodies) 1 is held in the through holes 2h, and low-viscosity resin layers 3A and 3B are stacked on the top and bottom surfaces thereof may be employed. In such a case, the insulating film 2 is formed of a resin layer less prone to deformation by heat or pressure than the low-viscosity resin layers 3A and 3B. The relationship in physical properties between the resin layers to be stacked is not limited thereto, and may be changed as appropriate depending on the intended use.

The smoothness of the object to which the pseudo random dot pattern of the present invention is provided is not limited in particular. The object may be smooth, uneven, or undulated.

A smooth surface where the pseudo random dot pattern is provided may be subjected to undulating treatment. The pseudo random dot pattern may be provided on a plane undulated in advance. The undulation may be such that the pseudo random dot pattern can be identified. For example, the surface may be undulated within one cycle in the y direction in FIG. 1A, or undulated over a plurality of cycles.

The material of the surface to which the pseudo random dot pattern is provided is not limited in particular. For example, conventional resins may be used. Inorganic materials such as a metal, an alloy, glass, and ceramics may be used. An organic-inorganic hybrid material or a surface including both organic and inorganic materials (examples include a transparent conductive film where ITO wiring is provided) may be used. As a method for disposing the pseudo random dot pattern on a flat resin film, methods described in the publications cited above can be used.

### EXAMPLES

The present invention will now be specifically described in conjunction with practical examples.

A simulation was performed assuming that a filler-containing film including a resin film where filler particles are disposed in a pseudo random dot pattern was held between fan-out-patterned areas including radially arranged rectangular regions and thermally pressure-bonded. Here, in light of the movement of filler particles clue to resin flow of the resin film, whether filler particles were held in the fan-out-patterned areas were evaluated in the following manner.

### Experimental Examples 1 to 5

Table 1 shows specifications of a fan-out-patterned areas A and B. Table 2 shows filler particle dispositions (with spherical filler particles of 3 μm in diameter) of experimental examples 1 to 5, and evaluation items (a) to (d) and evaluation results in cases where the filler-containing films were thermally pressure-bonded. Of these experimental examples, experimental examples 1 to 3 are examples of the present invention. The following evaluation criteria are expedient criteria for evaluating pseudo randomness.

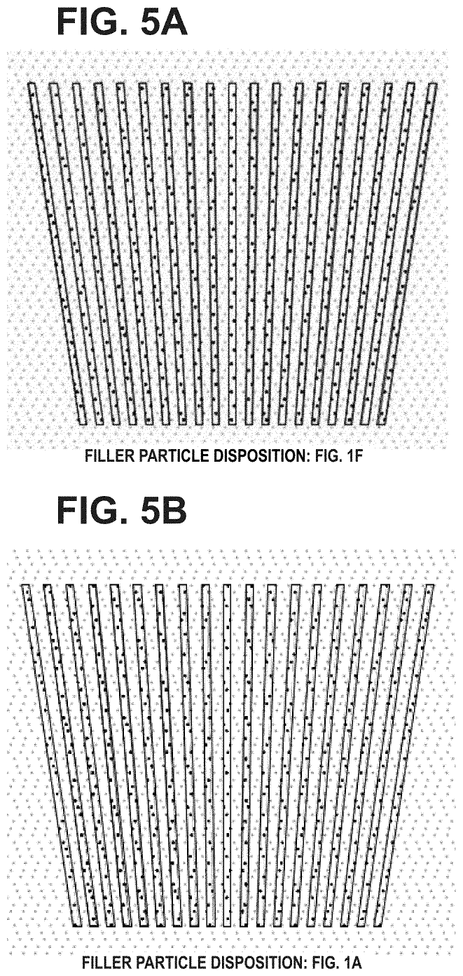

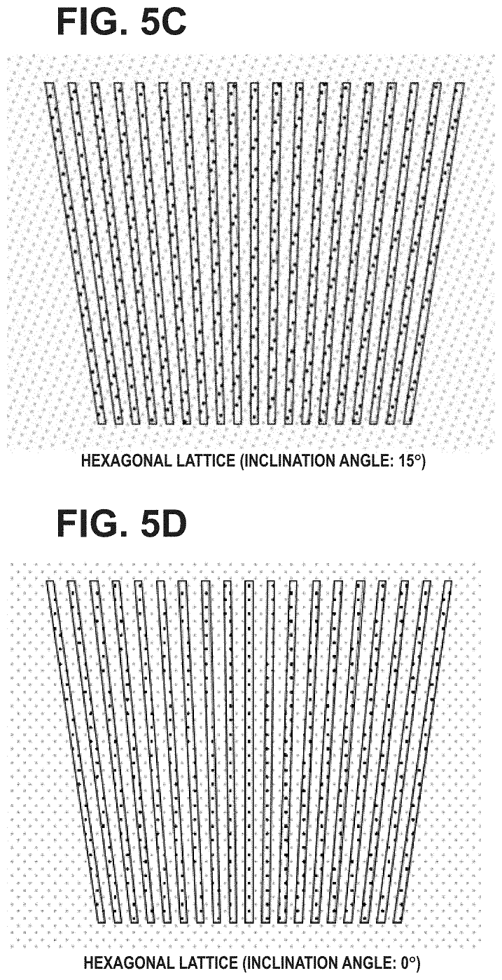

Regarding the evaluation results of (d), FIGS. 5A to 5D show simulation results of the number of filler particles overlapping the rectangular regions of fan-out-patterned areas B using the filler particle dispositions of experimental examples 1, 3, 4, and 5 with a number density of 16000 pieces/mm² (the ratios of increase in the inter-filler-particle distance on a rectangular region and in a gap region between two rectangular regions were the same as in Table 1).

In this simulation, the arrangement direction of each rectangular region was the same as the x direction of the filler-containing films (FIGS. 1A and 1F). The ratio of increase in the inter-filler-particle distance on a rectangular region in the x direction or y direction and the ratio of increase in the inter-filler-particle distance in a gap region between two rectangular regions in the x direction or y direction, shown in Table 1, are average values obtained by measuring the corresponding ratios of the filler-containing films in similar regions a plurality of times in advance.
(a) The minimum number of filler particles overlapping each rectangular region (simulation with fan-out-patterned areas A)

OK: five or more

NG: four or less
(b) The number of filler particles interconnected in the long-side direction of the rectangular regions in a gap region between two rectangular regions (simulation with fan-out-patterned areas B)

OK: three or less

NG: four or more
(c) The number of filler particles forming a straight row on a rectangular region (simulation with fan-out-patterned areas B)

OK: three or less

NG: four or more
(d) The horizontal uniformity of the numbers of filler particles overlapping rectangular regions at left and right symmetrical positions from the center of the fan-out-patterned areas in the width direction (simulation with fan-out-patterned areas B)

Uniform: distribution patterns of filler particles overlapping rectangular regions at left and right symmetrical positions from the center of the fan-out-pattern areas in the width direction look the same

Nonuniform: distribution patterns of filler particles overlapping rectangular regions at left and right symmetrical positions from the center of the fan-out-pattern areas in the width direction do not look the same

TABLE 1
Specifications of Fan-Out-Patterned Areas

| | |
|---|---|
| Fan-Out- | Fan-Out- |
| Patterned | Patterned |
| Area A | Area B |

| | | | | |
|---|---|---|---|---|
| Length of Rectangular Region | 400 | μm | 400 | μm |
| Width of Rectangular Region | 4 | μm | 8 | μm |
| Arrangement Pitch (*5) | 20 | μm | 20 | μm |

| | | |
|---|---|---|
| Fan-Out Angle | −9° to 9° | −9° to 9° |

| Number of Arrangements | 19 | 19 |
|---|---|---|
| Ratio of Increase in Inter-Filler- | 1.7 | 1.7 |
| Particle Distance on Rectangular | | |
| Region (x Direction) (*1) | | |
| Ratio of Increase In Inter-Filler- | 1.1 | 1.1 |
| Particle Distance On Rectangular | | |
| Region (y Direction) (*2) | | |
| Ratio of Increase in Inter-Filler- | | 1 |
| Particle Distance in Gap Region | | |
| (x Direction) (*3) | | |
| Ratio of Increase in Inter-Filler- | | 1 |
| Particle Distance in Gap Region | | |
| (y Direction) (*4) | | |

[Notes]
x direction: arrangement direction of rectangular regions
y direction: direction perpendicular to x direction
(*1) Ratio of inter-filler-particle distance after pressure bonding to that before pressure bonding in x direction on rectangular region
(*2) Ratio of inter-filler-particle distance after pressure bonding to that before pressure bonding in y direction on rectangular region
(*3) Ratio of inter-filler-particle distance after pressure bonding to that before pressure bonding in x direction in gap region between two rectangular regions
(*4) Ratio of inter-filler-particle distance after pressure bonding to that before pressure bonding in y direction in gap region between two rectangular regions
(*5) Arrangement pitch at bottom side of radial arrangement (minimum pitch)

From Table 2, it can be seen that experimental examples 1 to 3 were OK on all the evaluation items. Filler particles uniformly overlapped each rectangular region in the fan-out-patterned areas. The numbers of filler particles interconnected in the y direction in a gap region and the numbers of filler particles forming a row on a rectangular region decreased. The states of overlap of the left and right rectangular regions is the fan-out-patterned areas with filler particles were also uniform.

By contrast, in experimental example 4, the number of filler particles forming a row on a rectangular region and the number of filler particles interconnected in the y direction in a gap region were large, and the horizontal uniformity was poor. In experimental example 5, it can be seen that the horizontal uniformity was good but the number of filler particles overlapping a rectangular region was insufficient. It can also be seen from FIGS. 5A to 5D that the filler particle dispositions of the experimental examples corresponding to the examples of the present invention improve the overlapping uniformity of the fan-out-patterned areas and the filler particles.

While experimental examples 1 to 5 show the effect of the pseudo random dot pattern in the case where resin flow affects the filler particle disposition, the effect of the pseudo random dot pattern can be obtained without being limited to the case where filler particles are included in a resin.

The use of the filler-containing film where filler particles are disposed in the pseudo random dot pattern is not limited to pressure bonding to an object, either.

### REFERENCE SIGNS LIST

1 dot, filler, fine solid body

2 insulating resin layer, insulating film

2h through hole

3, 3A, 3B low-viscosity resin layer

10A, 10B, 10C, 10D, 10E pseudo random dot pattern

11, 11a, 11b first oblique lattice region

12, 12a, 12b second oblique lattice region

20 rectangular region

21 fan-out-patterned area

22 parallel-patterned area

100A, 100B, 100C filler-containing film

a1 arrangement axis of first oblique lattice region

a2 arrangement axis of second oblique lattice region

b direction of arrangement axis obliquely crossing arrangement axis x in first oblique lattice region

c direction of arrangement axis obliquely crossing arrangement axis x in second oblique lattice region

Ld amount of deviation

s amount of distortion

x arrangement direction of rectangular region

y direction perpendicular to x direction, direction of y axis in xy plane

pa dot pitch in arrangement axis

α angle formed between x direction and b direction

β fan-out angle when fan-out arrangement is adopted, or angle formed between arrangement direction of rectangular region and long-side direction of rectangular region when fan-out arrangement is not adopted

γ inclination angle of arrangement axis of hexagonal lattice with respect to x direction

1. A pseudo random dot pattern comprising a first oblique lattice region and a second oblique lattice region repeatedly disposed at predetermined intervals in a y direction on an xy plane, a plurality of dot arrangement axes a1 on which dots are disposed at a predetermined pitch in an x direction being arranged in a b direction obliquely crossing the x direction at an angle α in the first oblique lattice region, a plurality of dot arrangement axes a2 on which dots are disposed at a predetermined pitch in the x direction being arranged in a c direction reverse to the b direction with respect to the x direction in the second oblique lattice region.

2. The pseudo random dot pattern according to claim 1, wherein the first oblique lattice region and the second oblique lattice region are repeatedly disposed so that, regarding the arrangement axis obliquely crossing the x direction, an extension of the arrangement axis in one of the oblique lattice regions does not serve as the arrangement axis in the other oblique lattice region.

3. The pseudo random dot pattern according to claim 1, wherein the first oblique lattice region and the second oblique lattice region are alternately repeatedly disposed.

4. The pseudo random dot pattern according to claim 1, wherein the respective dots are disposed at a constant pitch on the arrangement axes a1 in the first oblique lattice region and on the arrangement axes a2 in the second oblique lattice region.

5. The pseudo random dot pattern according to claim 4, wherein a pitch at which the dots are disposed on the arrangement axes a1 in the first oblique lattice region and a pitch at which the dots are disposed on the arrangement axes a2 in the second oblique lattice region are the same.

6. The pseudo random dot pattern according to claim 1, wherein a distance L1 between adjoining arrangement axes a1 in the first oblique lattice region and a distance L2 between adjoining arrangement axes a2 in the second oblique lattice region are the same.

7. The pseudo random dot pattern according to claim 1, wherein positions of closest dots on the arrangement axis a1 of the first oblique lattice region and an adjoining arrangement axis a2 of the second oblique lattice region are deviated in the x direction.

8. The pseudo random dot pattern according to claim 1, wherein a number of the arrangement axes a1 arranged in the first oblique lattice region and a number of the arrangement axes a2 arranged in the second oblique lattice region are the same.

9. The pseudo random dot pattern according to claim 1, wherein a number of the arrangement axes a1 arranged in the first oblique lattice region and a number of the arrangement axes a2 arranged in the second oblique lattice region are 4 or less.

10. A creation method of a pseudo random dot pattern, the creation method comprising repeatedly disposing a first oblique lattice region and a second oblique lattice region at predetermined intervals in a y direction on an xy plane, a plurality of dot arrangement axes a1 on which dots are disposed at a predetermined pitch in an x direction being arranged in a b direction obliquely crossing the x direction at an angle α in the first oblique lattice region, a plurality of dot arrangement axes a2 on which dots are disposed at a predetermined pitch in the x direction being arranged in a c direction reverse to the b direction with respect to the x direction in the second oblique lattice region.

11. A filler-containing film comprising a resin layer where filler particles are disposed in a pseudo random dot pattern on an xy plane, the filler-containing film including a first oblique lattice region and a second oblique lattice region repeatedly disposed at predetermined intervals in a y direction, a plurality of filler particle arrangement axes a1 on which filler particles are disposed at a predetermined pitch in an x direction being arranged in a b direction obliquely crossing the x direction at an angle α in the first oblique lattice region, a plurality of filler particle arrangement axes a2 on which filler particles are disposed at a predetermined pitch in the x direction being arranged in a c direction reverse to the b direction with respect to the x direction in the second oblique lattice region.

12. The filler-containing film according to claim 11, wherein the first oblique lattice region and the second oblique lattice region are repeatedly disposed so that, regarding the arrangement axis obliquely crossing the x direction, an extension of the arrangement axis in one of the oblique lattice regions does not serve as the arrangement axis in the other oblique lattice region.

13. The filler-containing film according to claim 11, wherein the arrangement axes a1 are parallel to a long-side direction of the film.
